(19) United States
(12) Patent Application Publication
(10) Pub. No.: US 2005/0256921 A1
(43) Pub. Date: Nov. 17, 2005

(54) Delay calculation method, timing analysis method, calculation object network approximation method, and delay control method

(75) Inventors: Naoki Amekawa, Ota-ku (JP); Takahiro Ichinomiya, Katano-shi (JP); Kazuhiro Satoh, Neyagawa-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/891,496

(22) Filed: Jul. 15, 2004

(30) Foreign Application Priority Data
Jul. 16, 2003 (JP) 2003-275246

(51) Int. Cl. G06G 7/00

(52) U.S. Cl. 708/800

(57) ABSTRACT

A delay calculation method considering a net adjacent to a delay calculation object net of a semiconductor integrated circuit includes: an adjacent net internal resistance selecting step of selecting a combination of static state of an adjacent net driving cell; a coupling capacitance grounding step of multiplying a coupling capacitance by a coefficient obtained from an internal resistance of the adjacent net driving cell selected by the adjacent net internal resistance selecting step, and the like, and grounding the value obtained thereby as the coupling capacitance of the delay calculating object net; and a delay value deriving step of deriving the delay value from a circuit obtained by these steps. A problem of the delay calculation method that an accurate delay value cannot be obtained because in actuality, the adjacent wire whose potential fluctuates is approximated to zero potential is solved by this structure.

### BACKGROUND OF THE INVENTION

1. Field of the Invention

The present invention relates to a delay calculation method, a timing analysis method, a calculation object network approximation method and a delay control method that are used for CAD apparatuses and the like for aiding the designing of semiconductor devices and speed up the delay time as a whole or speed up a given wire in the produced semiconductor device.

2. Description of the Prior Art

In recent years, since the semiconductor process has become finer and the capacitance stored between adjacent wires has been increased with respect to the substrate capacitance and the gate capacitance, performing a delay calculation considering the inter-wire capacitance by use of a CAD apparatus has been mainstream. Further, a method is commonly performed in which the potential fluctuation time of an adjacent wire is analyzed with a time width by a static analysis method and the delay fluctuation due to the inter-adjacent-wire capacitance is calculated.

Since the inter-wire capacitance causes cross talk phenomena such as delay fluctuation and noise, current CAD apparatuses have the function of performing an analysis considering an interference from an adjacent net provided through the inter-wire capacitance.

The current CAD apparatuses have the function of considering, when an adjacent net makes a transition simultaneously with the delay calculation object net in the delay calculation in a static timing analysis, the influence of the adjacent net on the delay value of the delay calculation object net.

Moreover, when no delay fluctuation due to cross talk is caused because the transition timing does not coincide with that of the adjacent wire in the delay calculation in the static timing analysis, the inter-wire capacitance is connected to ground. An example thereof is shown in FIGS. 27 to 29. FIG. 27 shows a circuit in which a net N001 comprising an instance I001 and an instance I002 and a net N002 comprising an instance I003 and an instance I004 are adjacent to each other with inter-wire capacitances C1 and C2 therebetween. FIG. 28 showing the transition timings of the net N001 and the net N002 indicates that the transitions of these nets are not made simultaneously. FIG. 29 is a view in which the inter-wire capacitances are connected to ground.

This grounding of the inter-wire capacitances is based on the assumption that non-transition nets are always at the power supply potential or at zero potential. Moreover, conventionally, no resistance component is considered when this grounding is performed.

In the delay calculation by CAD apparatuses, the capacitance and the resistance connected to the object wire largely affect the delay value thereof. Therefore, it is common practice to extract a wiring network conforming to the layout configuration and perform the delay calculation based on the network. However, as the minuteness of the extraction of the wiring network increases, the delay calculation time increases although the accuracy increases. Therefore, a technology is required of obtaining the delay in a realistic calculation time by simplifying the wiring network while maintaining a certain degree of accuracy.

For this reason, in the conventional network simplification, the capacitance stored between the delay calculation object wire and an adjacent wire is usually connected to ground as it is or after multiplied (for example, see Japanese Laid-Open Patent Application 2000-48053).

However, because of the increase in the inter-wire capacitance and the increase in wire resistance due to the process becoming finer and the reduction in power supply voltage due to the reduction in power consumption, the signal transition fluctuates the potential of the adjacent net as shown in FIG. 30, so that the power source or zero potential approximation of the adjacent net is becoming unfeasible.

When the delay calculation object net is activated, the potential of the adjacent net increases from the power supply potential or the zero potential, and when the delay calculation object net is deactivated, the potential of the adjacent net decreases from the power supply potential or the zero potential. Because of this fluctuation in the potential of the adjacent wire, the apparent inter-wire capacitance decreases and the actual delay value is lower than the delay value by grounding approximation.

### SUMMARY OF THE INVENTION

The present invention solves the above-mentioned conventional problems, and an object thereof is to more accurately obtain the delay value.

Moreover, when the capacitance stored between the delay calculation object wire and a wire adjacent thereto is connected to ground as it is or after multiplied as conventionally performed in the network simplification, the network can be easily simplified. However, since all the wires are equally connected to ground, for example, even if the average capacitance can be made uniform, the delay value is different from the intrinsic value under some conditions. Therefore, when a corner case timing verification is to be performed, such a verification cannot be performed or it is necessary to leave large equal margins.

Moreover, when an approximation to equally ground inter-wire capacitances is performed, a delay calculation considering cross talk cannot be performed.

The present invention is made in view of the above-mentioned problems, and an object thereof is to provide a delay calculation method and a timing analysis method capable of realizing a reduction in delay calculation time without significantly degrading the delay calculation accuracy.

A delay calculation method of the present invention is a delay calculation method considering a net adjacent to a delay calculation object net of a semiconductor integrated circuit, and includes: an adjacent net internal resistance selecting step of selecting a combination of static state of an adjacent net driving cell; and a coupling capacitance grounding step of multiplying a coupling capacitance stored between the delay calculation object net and the adjacent net by a coefficient obtained from a delay calculation object net transition, the coupling capacitance, a wire resistance of the adjacent net and a wire capacitance of the adjacent net which are obtained from the delay calculation object net and the adjacent net, and an internal resistance of the adjacent net driving cell selected by the adjacent net internal resistance selecting step, and grounding a value obtained thereby as a coupling capacitance of the delay calculating object net. A delay value is derived from a circuit obtained by these steps.

According to this structure, the difference in delay value by an adjacent wire when the circuit is at rest can be verified, so that timing analysis can be performed more accurately. Moreover, the calculation object network can be simplified in a form that reflects a realer behavior. Consequently, the delay value can be obtained more accurately, so that reduction in delay calculation time can be realized.

Another delay calculation method of the present invention is a delay calculation method considering a net adjacent to a delay calculation object net of a semiconductor integrated circuit, and includes: an adjacent net internal resistance selecting step of selecting a combination of static state of an adjacent net driving cell; and a coupling capacitance replacing step of calculating a current that flows through a coupling capacitance obtained from a delay calculation object net transition, a coupling capacitance stored between the delay calculation object net and the adjacent net, a wire resistance of the adjacent net and a wire capacitance of the adjacent net which are obtained from the delay calculation object net and the adjacent net, and an internal resistance of the adjacent net driving cell selected by the adjacent net internal resistance selecting step, and replacing the coupling capacitance and the adjacent net with a current source. A delay value is derived from a circuit obtained by these steps.

A timing analysis method of the present invention is a timing analysis method considering an influence of a delay value by a net adjacent to a net in a timing analysis object path of a semiconductor integrated circuit, and timing verification is performed by using, as a verification condition for a timing verification path, a delay value obtained by the delay calculation method according to claim 1 or 2.

According to this structure, timing verification can be performed by selecting a correct value for the verification condition for the timing verification path by use of the delay value obtained by the above-described delay calculation method, and similar effects to the above-mentioned ones are obtained.

A calculation object network approximation method of the present invention is a calculation object network approximation method considering a net adjacent to a driven net which is an object of calculation, and in accordance with a value of an internal resistance of a driving cell of the adjacent net and a resistance value of a path from the driving cell of the adjacent net to an inter-net capacitance stored between the driven net and the adjacent net, it is determined whether to approximate the inter-net capacitance to connection to ground or to hold a connection of the inter-net capacitance to the adjacent net.

According to this structure, the calculation object network can be simplified.

Another calculation object network approximation method of the present invention is a calculation object network approximation method considering a net adjacent to a driven net which is an object of calculation, and an inter-net capacitance stored between the driven net and the adjacent net is approximated to connection to ground through a value of an internal resistance of a driving cell of the adjacent net and an equivalent resistance corresponding to a resistance value of a path from the driving cell of the adjacent net to the inter-net capacitance.

According to this structure, approximation can be performed in accordance with the influence of the behavior of the adjacent wire.

Another calculation object network approximation method of the present invention is a calculation object network approximation method considering a net adjacent to a driven net which is an object of calculation, and includes: a step of calculating timing windows between the driven net and the adjacent net; and a step of, when the timing windows do not overlap, approximating to connection to ground an inter-wire capacitance stored between the driven net and the adjacent net by a capacitance and a resistance of the adjacent net and a value of an internal resistance of a driving cell.

According to this structure, since timing windows are considered, the amount of calculation object network can be reduced without any influence on the cross talk analysis.

Another calculation object network approximation method of the present invention is a calculation object network approximation method considering a net adjacent to a driven net which is an object of calculation, and in accordance with a resistance value of the driven net up to a part constituting an inter-wire capacitance with the adjacent net and a value of the inter-wire capacitance, the inter-wire capacitance is approximated to connection to ground.

According to this structure, since approximation is performed in consideration of a substantial influence of the inter-wire capacitance, the calculation object network can be reduced without a large delay error.

In a delay control method of the present invention, an electrically shielding wire is provided on a driven net which is an object of delay calculation, and the shielding wire is connected to a power source or ground by a high-resistance element.

According to this structure, for example, when there is a driven net whose wire delay in a semiconductor integrated circuit is to be speeded up, a shielding wire is provided on the track of the adjacent wire, and the shielding wire is connected to the power source or ground potential by use of a high-resistance element such as a PS resistance/OD resistance to thereby speed up the wire delay of the driven net. By connecting the shielding wire and the power source or ground by the high-resistance element, the difference in potential between the driven net and the shielding wire is reduced and the effective inter-wire capacitance is also reduced, so that the wire delay time of the driven net is reduced. According to this method, the effective inter-wire capacitance between the driven net and the shielding wire can be reduced, so that the wire delay time of the driven net can be reduced.

In another delay control method of the present invention, an electrically shielding wire is provided on a driven net which is an object of delay calculation, the shielding wire is connected to a power source or ground by a controllable resistance element, and a resistance value in the shielding wire is controlled to thereby control a delay value of the driven net.

According to this structure, for example, when there is a driven net whose wire delay time is necessarily controlled in a semiconductor integrated circuit, a shielding wire is provided on the track of the adjacent wire, and the shielding wire is connected to the power source or ground potential by use of variable resistance elements such as transistors connected in parallel, thereby controlling the wire delay of the driven net. By thus connecting the shielding wire and the power source or ground by the variable resistance elements, the delay time control of the wire whose delay value is to be controlled can be performed. According to this technique, the effective inter-wire capacitance between the driven net and the shielding wire can be controlled, so that the wire delay time of the driven net can be controlled.

In a delay control method of the present invention, an electrically shielding wire is provided on a driven net which is an object of delay calculation, the shielding wire is connected to a power source or ground by a controllable resistance element, after an LSI is manufactured, operation verification is performed and a wire whose delay varies due to a variation in process is extracted, and a resistance value in the shielding wire is controlled to thereby control a varying delay value of the driven net.

According to this structure, for example, when there is a driven net whose wire delay time is necessarily controlled in a semiconductor integrated circuit, a shielding wire is provided on the track of the adjacent wire, and the shielding wire is connected to the power source or ground potential by use of variable resistance elements such as transistors connected in parallel, thereby controlling the wire delay of the driven net to increase the operation assurance range of the LSI. By controlling the delay time of the wire whose delay value is to be controlled by connecting the shielding wire and the power source or ground by the variable resistance elements, yield can be improved.

According to this technique, by extracting a variation in delay due to a variation in process detected after the manufacture of the LSI and controlling the effective inter-wire capacitance between the driven net and the shielding wire, the wire delay time of the driven net can be controlled and the reduction in yield due to a variation in process can be improved.

In another delay control method of the present invention, an electrically shielding wire is provided on a driven net which is an object of delay calculation, the shielding wire is connected to a power source or ground by a controllable resistance element, an influence on a wire delay of the driven net is calculated from a delay time fluctuation detected by an apparatus that detects a delay time fluctuation at a given point in an LSI, and a resistance value in the shielding wire is controlled so that the wire delay fluctuation of the driven net is suppressed.

This structure is a delay value control method in which, for example, when there is a driven net whose wire delay time is necessarily controlled in a semiconductor integrated circuit, a shielding wire is provided on the track of the adjacent wire, the shielding wire is connected to the power source or ground potential by use of variable resistance elements such as transistors connected in parallel, and by use of a circuit that detects a delay fluctuation in the LSI and a variable resistance control circuit for reducing the delay fluctuation, the delay time of the wire is controlled while the LSI is operating, thereby achieving circuit stabilization. By controlling the wire delay time of the driven net by controlling the effective inter-wire capacitance between the driven net and the shielding net by use of the delay fluctuation detecting circuit and the variable resistance control circuit, stabilization of the LSI circuit can be achieved.

According to this technique, by dynamically controlling the varying delay time of the driven net while the LSI is operating, the operation assurance range can be increased. For example, by detecting a delay fluctuation due to a temperature variation in the chip or a potential variation in the chip which variation is caused while the LSI is operating and controlling the inter-wire capacitance between the shielded net and the shielding wire, the wire delay time fluctuation of the driven net is dynamically corrected while the LSI is operating, where circuit operation can be stabilized.

In another delay control method of the present invention, a delay fluctuation due to a temperature change of a shielded net is calculated, a capacitance stored between a shielded wire and a shielding wire that suppresses the delay fluctuation due to the temperature change of a driving cell of the shielded net and a resistance value of an element connecting the shielding wire to a power source or ground are calculated, an electrically shielding wire constituting the calculated inter-wire capacitance is provided on the shielded wire, and the shielding wire is connected to the power source or ground by the element of the calculated resistance value.

This structure is a delay value stabilization method in which, for example, when there is a shielded net, for example a driven net, whose wire delay time is necessarily controlled in a semiconductor integrated circuit, a fluctuation in the driving cell and the wire delay of the driven net due to a temperature change is calculated, an element resistance with a high temperature coefficient that connects the inter-shielding-wire capacitance necessary for reducing the delay fluctuation and the shielding wire to the power source/ground is calculated, the shielding wire is provided so that the inter-wire capacitance value is the calculated one, and connection is made to the power source/ground by a resistance element of the calculated element resistance value to thereby suppress the delay fluctuation due to the temperature change. By providing the shielding wire so that the inter-wire capacitance and the element resistance value are the calculated ones, the temperature change of the wire delay can be suppressed.

According to the delay value stabilization method of this technique, by the effective inter-wire capacitance between the driven net and the shielding wire changing in response to the delay fluctuation due to a temperature variation in the chip caused while the LSI is operating, the temperature dependence of the shielded wire due to a temperature distribution in the chip is suppressed and the wire delay time fluctuation of the driven net is automatically corrected while the LSI is operating, whereby circuit operation can be stabilized.

In another delay control method of the present invention, a plurality of elements that drive a wire adjacent to a driven net which is an object of delay calculation is connected, switching is made between an element when the adjacent wire is driven and an element when the adjacent wire is not driven, and an internal resistance of a driving cell of the adjacent wire is varied to thereby control a delay value of the driven net.

This structure is a delay value control method in which, for example, when there is a driven net whose wire delay time is necessarily controlled in a semiconductor integrated circuit, the transistor that drives the adjacent wire is changed to a plurality of or a plurality of pairs of transistors, switching is made between a transistor having a driving force required when the adjacent wire makes a state transition and a transistor used for fixing the potential in the steady state, the resistance value connected to the adjacent wire and the power source/ground is changed, and the delay value of the driven net is controlled. By switching the driving transistor of the signal wire driven by a plurality of pairs of transistors, the resistance value between the signal wire and the power source/ground is changed and the effective inter-wire capacitance between the driven net and the adjacent wire is controlled, whereby the delay time of the driven net can be controlled.

According to this technique, even in LSIs in which the space for the adjacent wire track of the driven net is tight, by changing the driving transistor of the adjacent wire to a plurality of transistors without the provision of a shielding wire and switching between the transistors, the influence of the adjacent wire on the delay time is suppressed, whereby the delay time of the driven net can be controlled.

### BRIEF DESCRIPTION OF THE DRAWINGS

FIG. 1 is a flowchart showing the procedure of a delay calculation method according to a first embodiment of the present invention;

FIG. 2 is a circuit diagram for explaining a first to a third embodiment of the present invention;

FIG. 3 is a view for explaining a method of obtaining the signal transition time of nodes to which inter-wire capacitances are connected in the first to third embodiments of the present invention;

FIG. 4 is a view for analyzing adjacent nets to which the inter-wire capacitances are connected in the first to third embodiments of the present invention;

FIG. 5 is a view showing a condition in which the potentials of adjacent nets fluctuate in the first or third embodiment of the present invention;

FIG. 6 is a view showing a condition in which the inter-wire capacitances are replaced with equivalent capacitances in the first or third embodiment of the present invention;

FIG. 7 is a flowchart showing the procedure of a delay calculation method according to the second embodiment of the present invention;

FIG. 8 is a view showing the waveforms of currents flowing into inter-wire capacitances in the second or third embodiment of the present invention;

FIG. 9 is a view showing a condition in which the inter-wire capacitances are replaced with equivalent capacitances in the first or third embodiment of the present invention;

FIG. 10 is a flowchart showing the procedure of a timing analysis method according to the third embodiment of the present invention;

FIG. 11 is a circuit diagram for explaining an example of the third embodiment of the present invention;

FIG. 12 is a circuit diagram for explaining the example of the third embodiment of the present invention including the delay values obtained by the first or second embodiment of the present invention;

FIG. 13 is an explanatory view of a calculation object network simplified in a fourth embodiment of the present invention;

FIG. 14 shows an example of an equivalent circuit of a typical driving cell;

FIG. 15 is a circuit diagram showing a calculation object network after approximation;

FIG. 16 is a flowchart showing a calculation object network approximation method;

FIG. 17 is a circuit diagram showing a calculation object network in which an inter-wire capacitance is approximated to connection to ground;

FIG. 18 is a flowchart showing an eighth embodiment of the present invention;

FIG. 19(a) is an explanatory view showing a conventional connection using a low-resistance element;

FIGS. 19(b) and 19(c) are explanatory views each showing a connection, to the power source/ground, using a high-resistance element;

FIG. 20 is a flowchart of a ninth embodiment of the present invention;

FIG. 21 is a view for explaining an example of a variable resistance element of the ninth embodiment of the present invention;

FIG. 22 is a flowchart showing a tenth embodiment of the present invention;

FIG. 23 is a flowchart showing an eleventh embodiment of the present invention;

FIG. 24 is a flowchart showing a twelfth embodiment of the present invention;

FIG. 25 is a flowchart showing a thirteenth embodiment of the present invention;

FIG. 26 is a circuit diagram of an example of a cell internal ON resistance switching element in the thirteenth embodiment of the present invention;

FIG. 27 is a circuit diagram of the conventional example;

FIG. 28 is a view showing the transition timings in the circuit of the conventional example;

FIG. 29 is a view showing the grounding approximation of the inter-wire capacitances in the conventional example; and

FIG. 30 is a view showing that the net whose potential is stationary fluctuates due to the transition of the adjacent net.

### DESCRIPTION OF THE PREFERRED EMBODIMENTS

Hereinafter, embodiments of the present invention will be described with reference to the drawings.

### First Embodiment

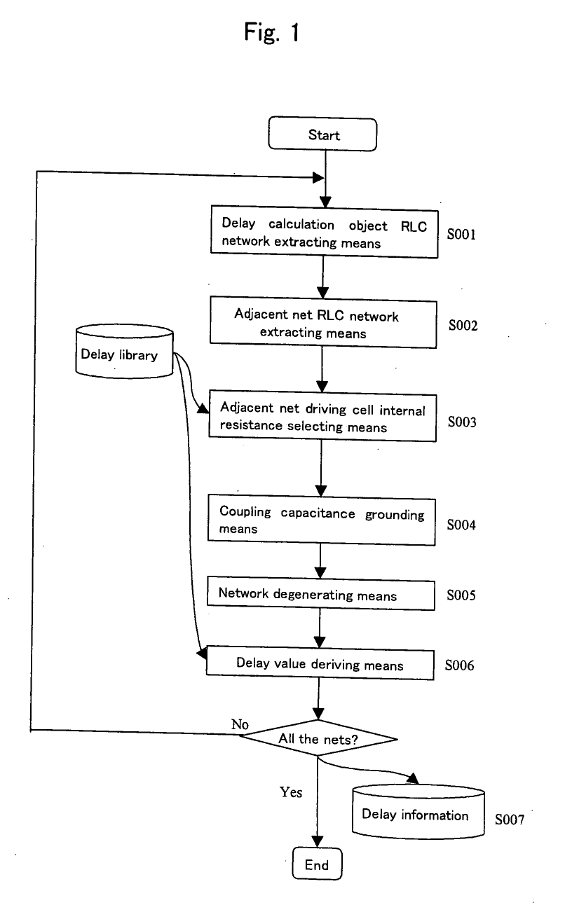

First, a delay calculation method in designing a semiconductor integrated circuit according to a first embodiment of the present invention will be described with reference to FIGS. 1 to 6. The first embodiment is a delay calculation method considering the influence of nets adjacent to the delay calculation object net in the delay calculation, on the delay value of the delay calculation object net.

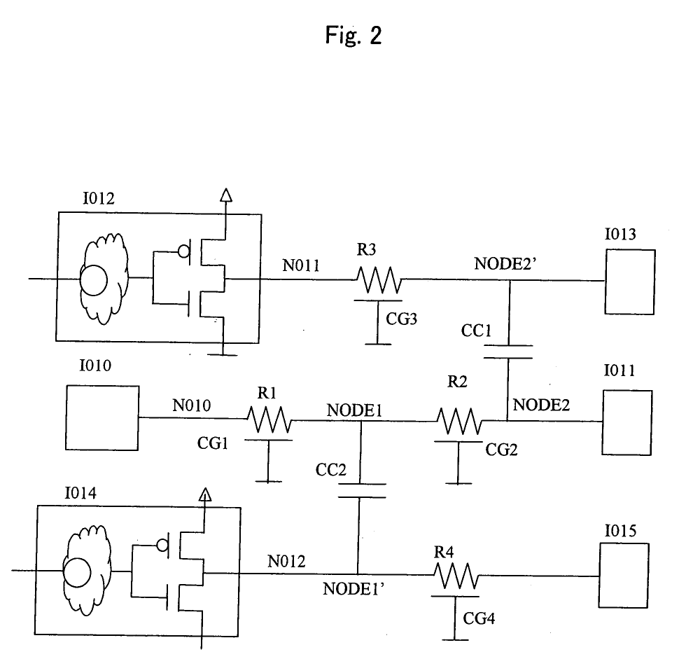

FIG. 1 is a flowchart showing the procedure of the delay calculation method according to the first embodiment. FIG. 2 is a diagram of a circuit comprising: a net N010 comprising an instance I010 and an instance I011; a net N011 comprising an instance I012 and an instance I013; and a net N012 comprising an instance I014 and an instance I015. The net N010 is coupled to the net N011 through an inter-wire capacitance CC1, and coupled to the net N012 through an inter-wire capacitance CC2. Wire resistances R1 and R2 and ground capacitances CG1 and CG2 are parasitic on the net N010, a wire resistance R3 and a ground capacitance CG3 are parasitic on the net N011, and a wire resistance R4 and a ground capacitance CG4 are parasitic on the net N012.

With this circuit as an example, the first embodiment will be described.

First, the wire resistances R1 and R2 and the ground capacitances CG1 and CG2 which are parasitic elements of the net N010 which is the object of the delay calculation, and the inter-wire capacitances CC1 and CC2 are extracted by delay calculation object RLC network extracting means S001. Then, the wire resistance R3 and the ground capacitance CG3, and the wire resistance R4 and the ground capacitance CG4 of the net N011 and the net N012 which are adjacent nets are extracted by adjacent net RLC network extracting means S002. The internal resistances of the instances I012 and I014 which are adjacent net driving cells described in a delay library are selected by adjacent net driving cell internal resistance selecting means S003. The internal resistance referred to here means the sum of the power supply voltage side or zero potential side driving transistor ON resistance of each of the adjacent net driving cells and the wire resistance in the cell.

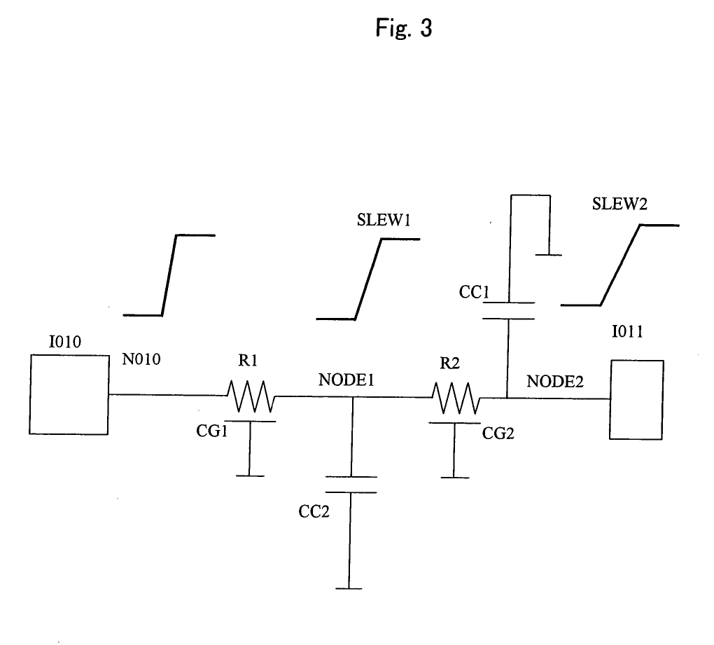

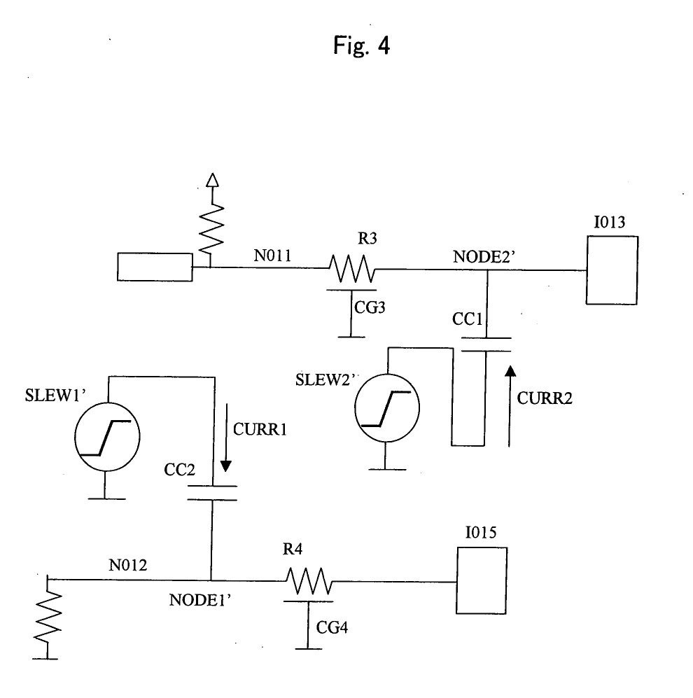

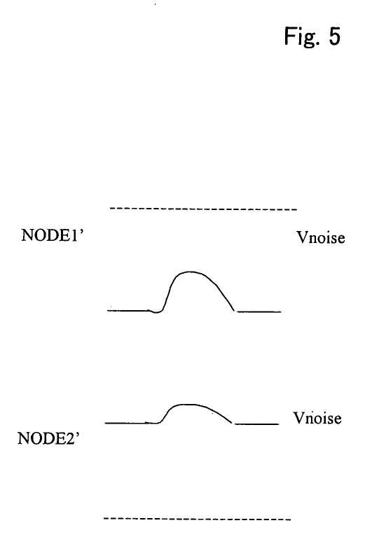

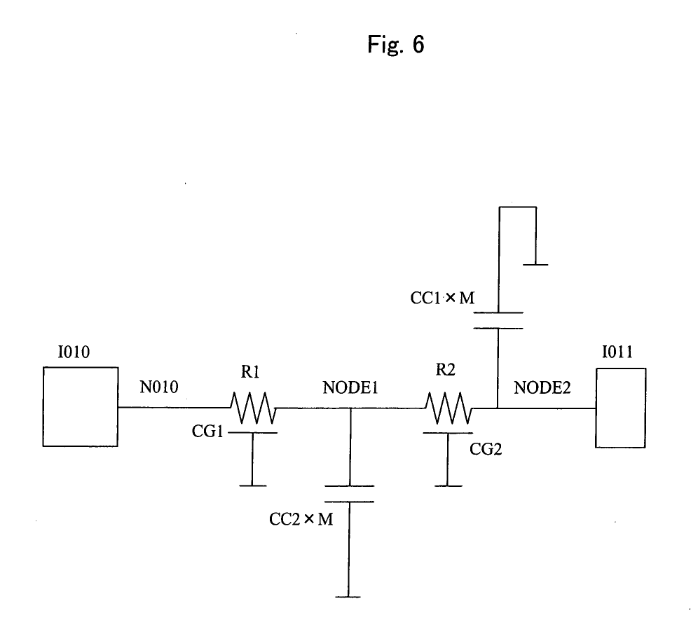

A coefficient M considering fluctuations in apparent inter-wire capacitance due to fluctuations in the potential of the adjacent net is obtained for all the inter-wire capacitances by coupling capacitance grounding means S004 with respect to the internal resistances obtained by the driving cell internal resistance selecting means S003. A method of deriving the coefficient considering fluctuations in apparent inter-wire capacitance due to potential fluctuations will be described. A slew SLEW1 and a slew SLEW2 of a node NODE1 and a node NODE2 of the net N010 which is the object of the delay calculation are obtained by use of the circuit shown in FIG. 3 in which the inter-wire capacitances are connected to ground. Potential increases Vnoise caused in all the adjacent nets are obtained by the circuit shown in FIG. 4 in which the slew SLEW1 and the slew SLEW2 are replaced with a voltage source SLEW1′ and a voltage source SLEW2′. FIG. 5 shows the potential increases Vnoise in the adjacent nets N011 and N012. From the potential increases Vnoise, the coefficient M considering fluctuations in apparent inter-wire capacitance due to potential fluctuations obtained by
M=(Vdd−Vnoise)/Vdd=α
is calculated. Here, Vdd is the power supply voltage, and α is a coefficient dependent on the potential waveform fluctuation configuration. FIG. 6 shows a circuit obtained by the coupling capacitance grounding means S004. This circuit is degenerated by network degenerating means S005, and the delay value and the slew at the termination of the net are calculated by use of the delay library by delay value deriving means S006. This procedure is repeated for all the nets, and delay information is outputted lastly.

### Second Embodiment

A delay calculation method in designing a semiconductor integrated circuit according to a second embodiment of the present invention will be described with reference to FIGS. 2 to 4 and 7 to 9. The second embodiment is a delay calculation method considering the influence of nets adjacent to the delay calculation object net in the delay calculation, on the delay value of the delay calculation object net.

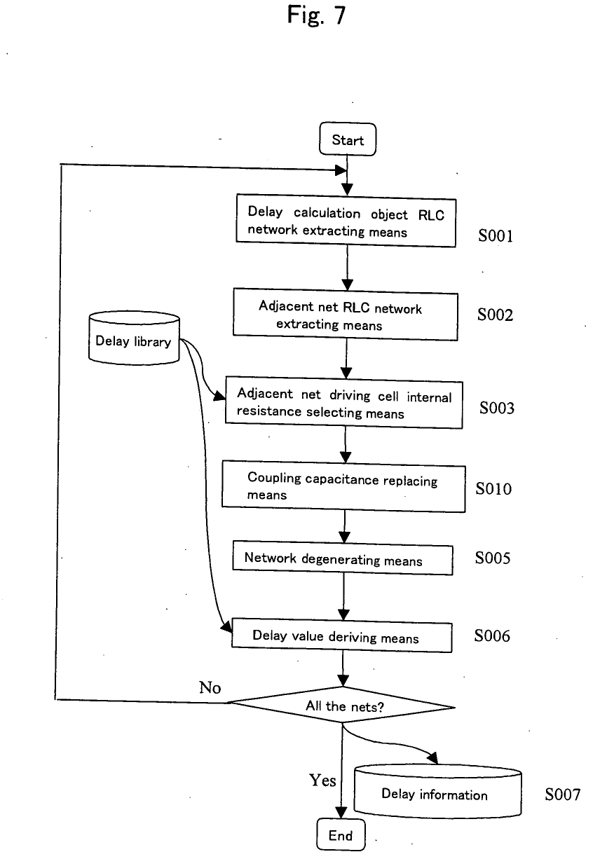

FIG. 7 is a flowchart showing the procedure of the delay calculation method according to the second embodiment. FIG. 2 is a diagram of a circuit comprising: a net N010 comprising an instance I010 and an instance I011; a net N011 comprising an instance I012 and an instance I013; and a net N012 comprising an instance I014 and an instance I015. The net N010 is coupled to the net N011 through an inter-wire capacitance CC1, and coupled to the net N012 through an inter-wire capacitance CC2. Wire resistances R1 and R2 and ground capacitances CG1 and CG2 are parasitic on the net N010, a wire resistance R3 and a ground capacitance CG3 are parasitic on the net N011, and a wire resistance R4 and a ground capacitance CG4 are parasitic on the net N012.

With this circuit as an example, the second embodiment will be described.

First, the wire resistances R1 and R2 and the ground capacitances CG1 and CG2 which are parasitic elements of the net N010 which is the object of the delay calculation, and the inter-wire capacitances CC1 and CC2 are extracted by delay calculation object RLC network extracting means S001. Then, the wire resistance R3 and the ground capacitance CG3, and the wire resistance R4 and the ground capacitance CG4 of the net N011 and the net N012 which are adjacent nets are extracted by adjacent net RLC network extracting means S002. The internal resistances of the instances I012 and I014 which are adjacent net driving cells described in a delay library are selected by adjacent net driving cell internal resistance selecting means S003. The internal resistance referred to here means the sum of the power supply voltage side or zero potential side driving transistor ON resistance of each of the adjacent net driving cells and the wire resistance in the cell.

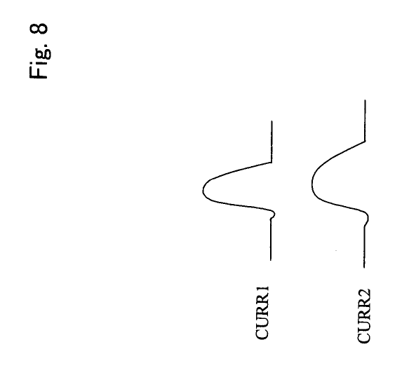

The part, of the inter-wire capacitances and succeeding elements, of the circuit when viewed from the delay calculation object net N010 is replaced with a current source that simulates the inter-wire capacitances and the loads of the adjacent nets by coupling capacitance replacing means S010. A method of the replacement will be described. A slew SLEW1 and a slew SLEW2 of a node NODE1 and a node NODE2 of the net N010 which is the object of the delay calculation are obtained by use of the circuit shown in FIG. 3 in which the inter-wire capacitances are connected to ground. Currents CURR flowing out to all the adjacent nets or flowing in from the adjacent nets are obtained by the circuit shown in FIG. 4 in which the slew SLEW1 and the slew SLEW2 are replaced with a voltage source SLEW1′ and a voltage source SLEW2′. FIG. 8 shows the currents flowing out from the voltage source SLEW1′ and the voltage source SLEW2′.

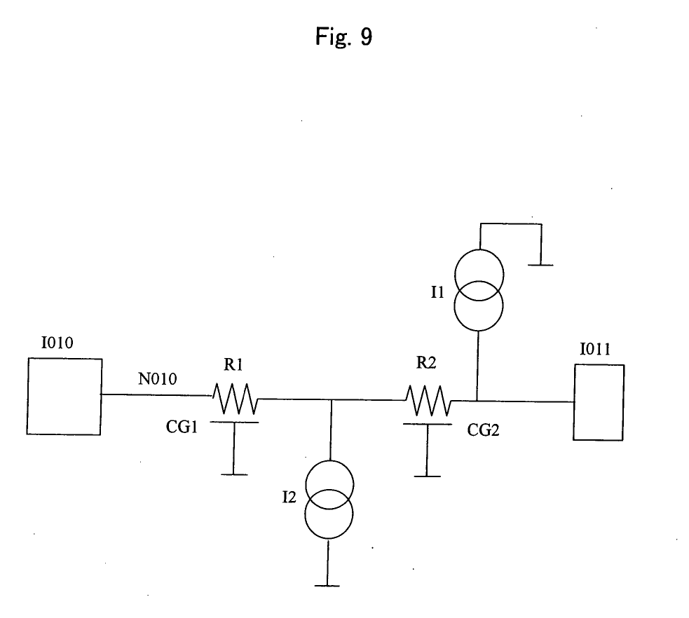

A current source I obtained by
I=CURR=β
is calculated from the currents CURR. Here, β is the coefficient dependent on the current waveform configuration. FIG. 9 shows a circuit obtained by the coupling capacitance replacing means S010. This circuit is degenerated by network degenerating means S005, and the delay value and the slew at the termination of the net are calculated by use of the delay library by delay value deriving means S006. This procedure is repeated for all the nets, and delay information is outputted lastly.

### Third Embodiment

A timing analysis method, in particular a static timing analysis method in designing a semiconductor integrated circuit according to a third embodiment of the present invention will be described.

The third embodiment is a timing analysis method where an analysis that is stricter in terms of timing is performed on a setup/hold timing restriction in consideration of the influence of a net adjacent to a net in a timing analysis object path, on the delay value of the net in the timing analysis object path.

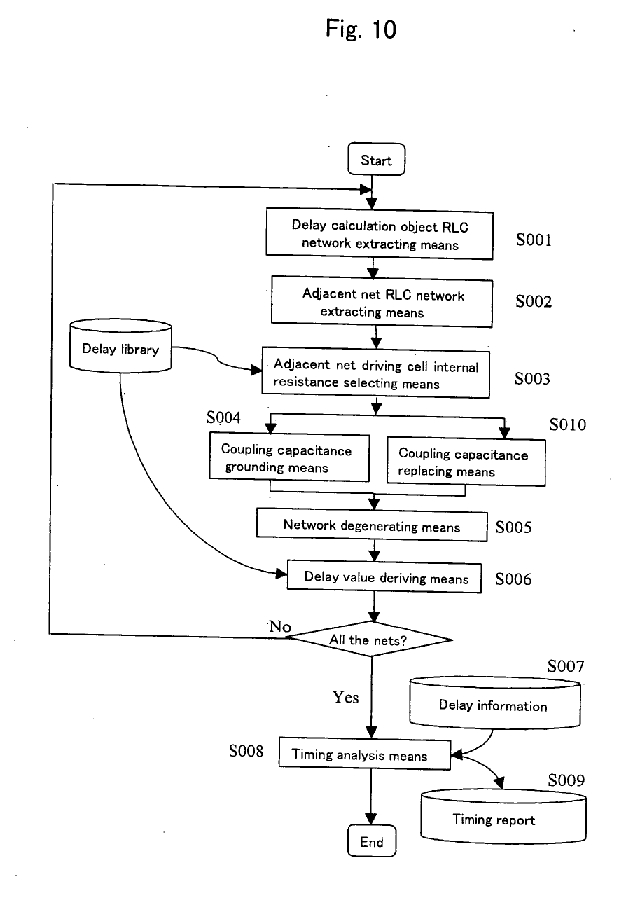

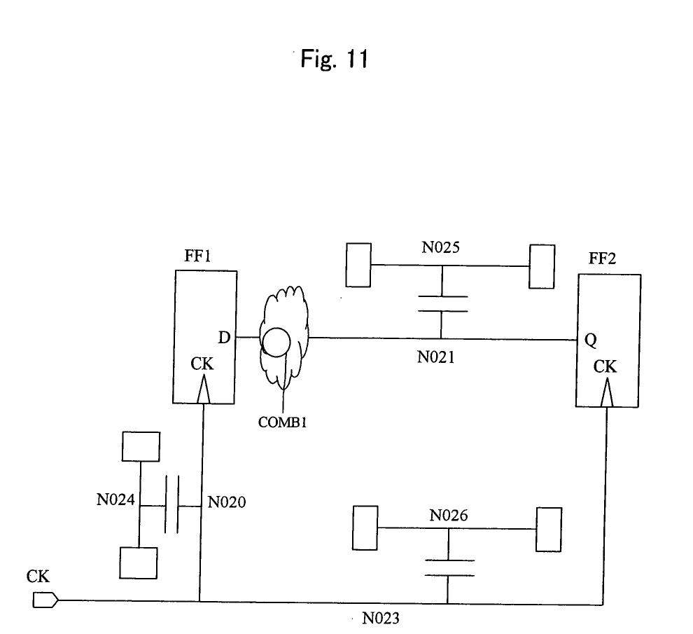

FIG. 10 is a flowchart showing the procedure of the timing analysis method according to the third embodiment. FIG. 11 shows a synchronous sequential circuit having: a net N020 from a clock source CK to a flip-flop FF1; a net N023 from the clock source CK to a flip-flop FF2; a combinational circuit COMB1 and a net N021 which are a path from the flip-flop FF1 to the flip-flop FF2; a net N024 adjacent to the net N020; a net N025 adjacent to the net N021; and a net N026 adjacent to the net N023.

With this circuit as an example, the third embodiment will be described.

As described in the first embodiment or the second embodiment, the highest and lowest delay values by the influence of the adjacent wire loads of the net N020, the net N023, the combinational circuit COMB1 and the net N021 of FIG. 11 are obtained by the delay calculation object RLC network extracting means S001, the adjacent net RLC network extracting means S002, the driving cell internal resistance selecting means S003, the coupling capacitance grounding means S004 or the coupling capacitance replacing means S010, the network degenerating means S005 and the delay value deriving means S006. Timing analysis means S008 performs timing analysis by use of the delay information S007, and records the result of the analysis in a timing report S009.

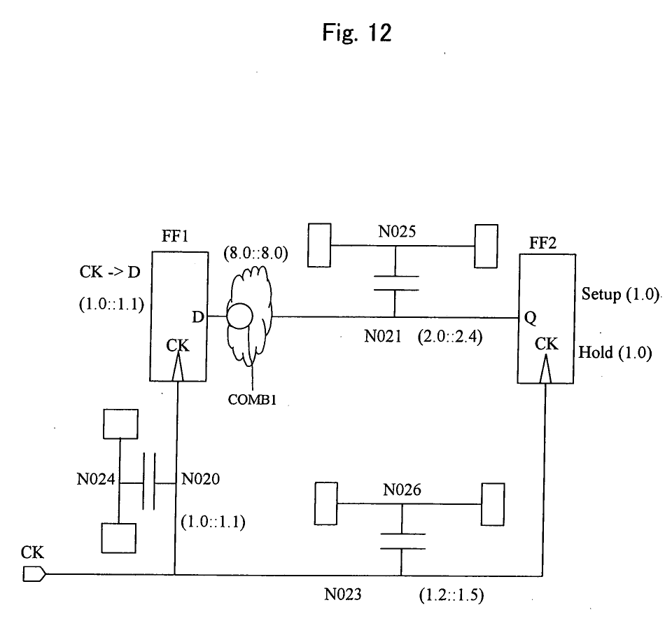

FIG. 12 shows the highest and lowest delay values of the nets and the combinational circuit. The numerical values on the left side in the parentheses are lowest delay values, and the numerical values on the right side in the parentheses are the highest values. Since the net N020 has an inter-wire capacitance between itself and the net N024, the net N021 has an inter-wire capacitance between itself and the net N025 and the net N023 has an inter-wire capacitance between itself and the net N026, the delay values thereof have the highest and lowest values. Moreover, since the slew at the termination of the net N020 has two values of the highest and lowest values, the delay value of the flip-flop FF1 also has two values of the highest and lowest values corresponding thereto. The setup time of the flip-flop FF2 has only one value because it is obtained by use of the highest value of the slew at the termination of the net N021 and the lowest value of the slew at the termination of the net N023. Moreover, the hold time of the flip-flop FF2 has only one value because it is obtained by use of the lowest value of the slew at the termination of the net N021 and the highest value of the slew at the termination of the net N023. The unit of time is ns (nanosecond).

A case will be described below where a setup verification of a path with a clock pin CK of the flip-flop FF1 as the start point and a data pin D of the flip-flop FF2 as the end point is performed.

In the setup verification, it is verified that the difference between the sum of the clock period, the lowest delay value of the net N023 and the setup time of the flip-flop FF2 and the sum of the highest delay value of the net N020, the highest delay value of the path from the clock pin CK of the flip-flop FF1 to the data pin D, the highest delay value of the combinational circuit COMB1 and the highest delay value of the net N021 is larger than zero. When the clock period is 10 ns, in the example,
(10.0+1.5+1.0)−(1.1+1.1+8.0+2.4)=−0.1,
and a setup error occurs (in the setup analysis, as the data transmission side clock, the later one is selected, and as the data reception side clock, the earlier one is selected).

A case will be described below where a hold verification of the path with a clock pin CK of the flip-flop FF1 as the start point and a data pin D of the flip-flop FF2 as the end point is performed.

In the hold verification, it is verified that the difference between the sum of the lowest delay value of the net N020, the lowest delay value of the path from the clock pin CK of the flip-flop FF1 to the data pin D, the lowest delay value of the combinational circuit COM1 and the lowest delay value of the net N021 and the sum of the highest delay value of the net N023 and the setup time of the flip-flop FF2 is larger than zero. In the example,
(1.0+1.0+8.0+2.0)−(1.2+1.0)=9.8,
and no hold error occurs (in the hold analysis, as the data transmission side clock, the earlier one is selected, and as the data reception side clock, the later one is selected).

### Fourth Embodiment

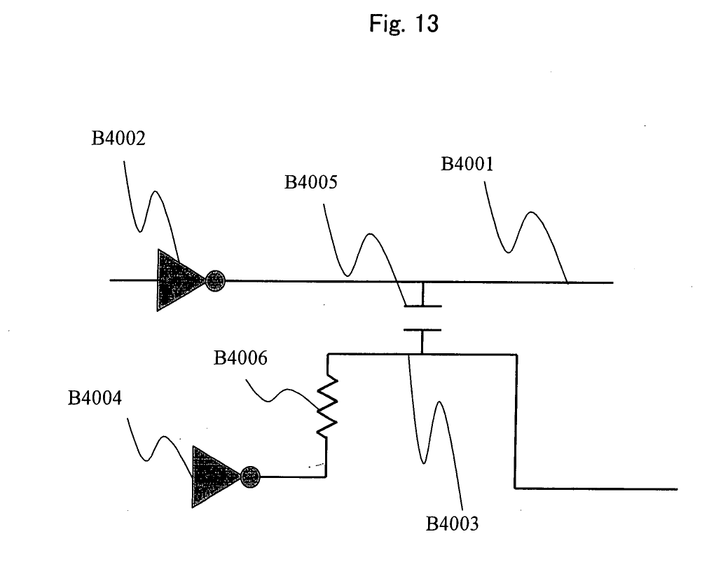

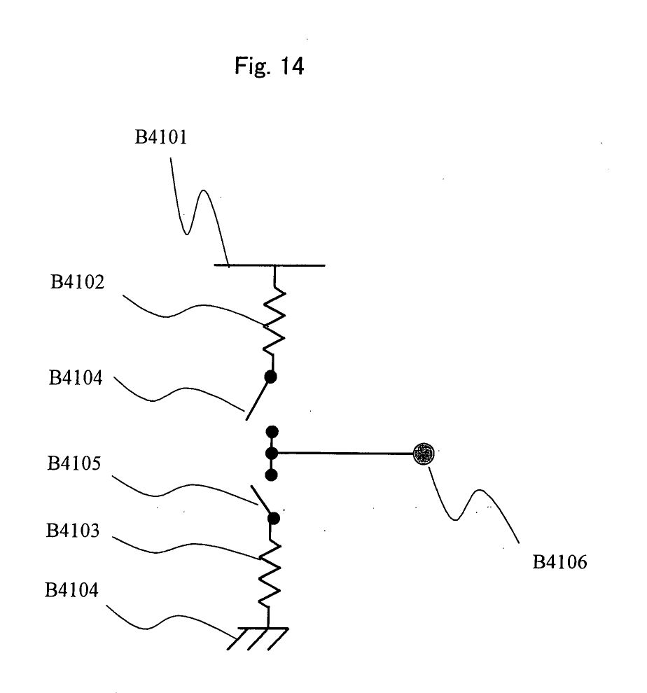

A fourth embodiment of the present invention will be described with reference to FIGS. 13 and 14.

FIG. 13 shows a calculation object network simplified in the fourth embodiment of the present invention. B4001 represents a driven wire, B4002 represents a driving cell, B4003 represents an adjacent wire, B4004 represents a cell that drives the adjacent cell, B4005 represents the inter-wire capacitance stored between the driven wire and the adjacent wire, and B4006 represents the resistance (Rw) of the path from the cell that drives the adjacent wire to the inter-wire capacitance.

FIG. 14 shows an example of an equivalent circuit of a typical driving cell. B4101 represents a power supply wire, B4102 represents a driving equivalent resistance (Rsp) when the driving cell outputs the power supply potential (Hi), B4103 is a driving equivalent resistance (Rsn) when the driving cell outputs the ground voltage (Lo), B4104 represents a switch that couples the driving equivalent resistance when Hi is outputted, to the output, B4105 represents a switch that couples the equivalent resistance when Lo is outputted, to the output, and B4106 represents the output. The driving equivalent resistance (Rsp) when the driving cell outputs the power supply potential (Hi) and the driving equivalent resistance (Rsn) when the driving cell outputs the ground potential (Lo) can generally be obtained as ON resistances of a transistor.

As mentioned previously, the inter-wire capacitance B4005 is affected by the resistance value Ra of the path from the adjacent wire B4003 to ground or to the power source. That is, when the resistance value Ra is low, the difference in behavior from when the inter-wire capacitance is directly connected to ground is small, whereas when the resistance value Ra is high, the behavior is different. Here, the resistance value Ra can be expressed as the sum of the resistance (Rw) B4006 of the path from the cell B4004 that drives the adjacent wire B4003 to the inter-wire capacitance B4005 and the higher one of the equivalent resistances Rsp and Rsn in the driving cell.

Therefore, when the resistance value Ra is lower than a set threshold value, for example 100 ohm, the inter-wire capacitance B4005 is approximated to connection to ground, and when the resistance value Ra is higher than the threshold value, the structure of the adjacent wire B4003 is left. By doing this, the calculation object network can be simplified while the structure that largely affects the behavior of the driven wire is left.

While the threshold value is 100 ohm in the example, it may be a value other than that. Moreover, the magnitude of the inter-wire capacitance may be further added as a parameter for performing simplification. For example, a structure may be adopted such that when the inter-wire capacitance is smaller than a given value, simplification to connection to ground may be equally performed.

Moreover, the ability of the driving cell may be added as a parameter for performing simplification. For example the degree of contribution of the inter-wire capacitance to the delay can be found from the inter-wire capacitance and the driving ability. Therefore, a structure may be adopted such that when the delay value is lower than a predetermined value, considering that the influence of the simplification on the inter-wire capacitance is small, simplification is equally performed.

### Fifth Embodiment

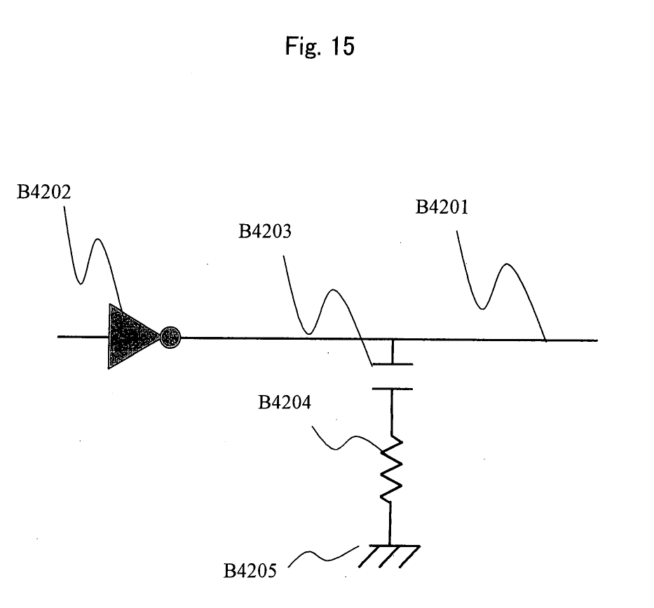

A fifth embodiment of the present invention will be described with FIGS. 13 and 15. Description will be given by use of FIGS. 13 and 15.

FIG. 15 is a view showing a calculation object network after approximation. B4201 represents a driven wire, B4202 represents a driving cell, B4203 represents an inter-wire capacitance corresponding to the inter-wire capacitance stored between the driven wire B4201 and an adjacent wire, B4204 represents an equivalent resistance coupling the approximate capacitance and ground, and B4205 represents ground.

In FIG. 13, the behavior of the driven wire B4001 is affected by the inter-wire capacitance B4005, and the inter-wire capacitance B4005 is affected by the behavior of the adjacent wire B4003. The inter-wire capacitance B4005 is affected by the resistance value Ra of the path from the adjacent wire B4003 to ground or the power source.

Therefore, approximation is performed with a model in which the inter-wire capacitance is connected to ground through the resistance value (Ra) of the path from the adjacent wire B4003 to ground or the power source, as the structure of the adjacent wire.

FIG. 15 which is an approximation of FIG. 13 shows a condition in which the inter-wire capacitance B4203 is connected to the ground B4205 through the resistance B4204 which is an approximation of the adjacent wire.

As the value of the inter-wire capacitance B4203, the value of the inter-wire capacitance B4005 may be used as it is or, for example, a value conforming to a function based on an actual simulation may be used.

Moreover, while connection is made to ground, it may be made to the power source. Further, the following may be performed: The driving equivalent resistance B4102 and the driving equivalent resistance B4103 in an equivalent model of the driving cell B4002 shown in FIG. 13 are compared, and the element to which connection is made is determined based on whether the degree of influence of the adjacent wire is to be regarded as rather high or rather low.

By the above-described method, approximation can be performed in accordance with the influence of the behavior of the adjacent wire.

### Sixth Embodiment

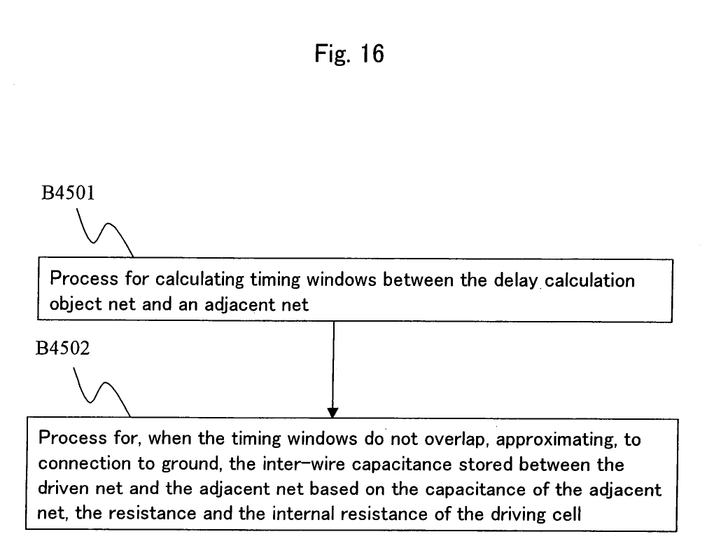

A sixth embodiment of the present invention will be described with reference to FIGS. 13, 16 and 17. In FIG. 16, B4501 of the wiring object network simplification is a process for calculating timing windows between the delay calculation object net and an adjacent net. The timing window defines a time period during which a transition can occur at a given position with respect to a predetermined time axis. In the calculation of the timing windows, the inter-wire capacitance is connected to ground, and after a brief delay calculation is performed, the timing windows are calculated so that a predetermined margin is left.

B4502 is a process for, when the timing windows do not overlap, approximating, to connection to ground, the inter-wire capacitance stored between the driven net and an adjacent net based on the capacitance and resistance of the adjacent net and the internal resistance of the driving cell. For example, in FIG. 13, when the timing windows at both ends of the inter-wire capacitance B4005 do not overlap, with the inter-wire capacitance B4005 as the object of approximation, the inter-wire capacitance B4005 is connected to ground and approximated. When the timing windows overlap, the inter-wire capacitance B4005 is held as it is.

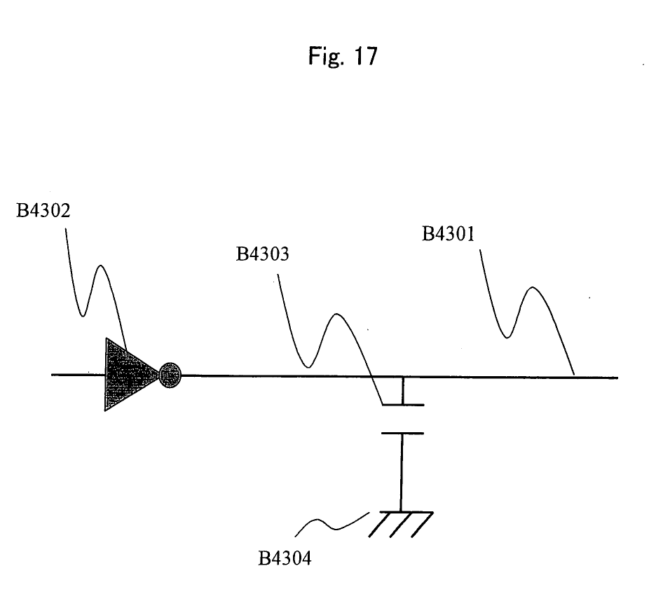

FIG. 17 shows a condition in which an inter-wire capacitance is grounded. B4301 represents a driven wire, B4302 represents a driving cell, B4303 represents an inter-wire capacitance, and B4304 represents ground.

With this structure, since the timing windows are considered, the amount of calculation object network can be reduced without any influence on the cross talk analysis.

While grounding approximation is performed in this example, a different approximation method may be used.

### Seventh Embodiment

A seventh embodiment of the present invention will be described with reference to FIG. 13. The influence of the inter-wire capacitance between the driven wire and an adjacent wire, on the driven wire differs according to the resistance value of the path from the driving cell to the inter-wire capacitance, and generally, the higher the resistance value of the path to the capacitance is, the smaller the influence thereof is.

Therefore, when the function of the resistance value (RI) of the path from the driving cell B4002 to the point where the inter-wire capacitance B4005 is coupled and the inter-wire capacitance (CC), that is, the product of the reciprocals of the squares of CC and R1 is higher than a threshold value 1 aF/ohm, the inter-wire capacitance is held as it is, and when it is smaller, the inter-wire capacitance is deleted, whereby the calculation object network can be simplified.

With this structure, since approximation is performed in consideration of a substantial influence of the inter-wire capacitance, the calculation object network can be reduced without a large delay error.

While the function is the product of the reciprocals of CC and RI in this example, it may be a different function. While the threshold value is 1 aF/ohm, it may be a different value. Moreover, the threshold value may be changed according to the ability of the driving cell.

### Eighth Embodiment

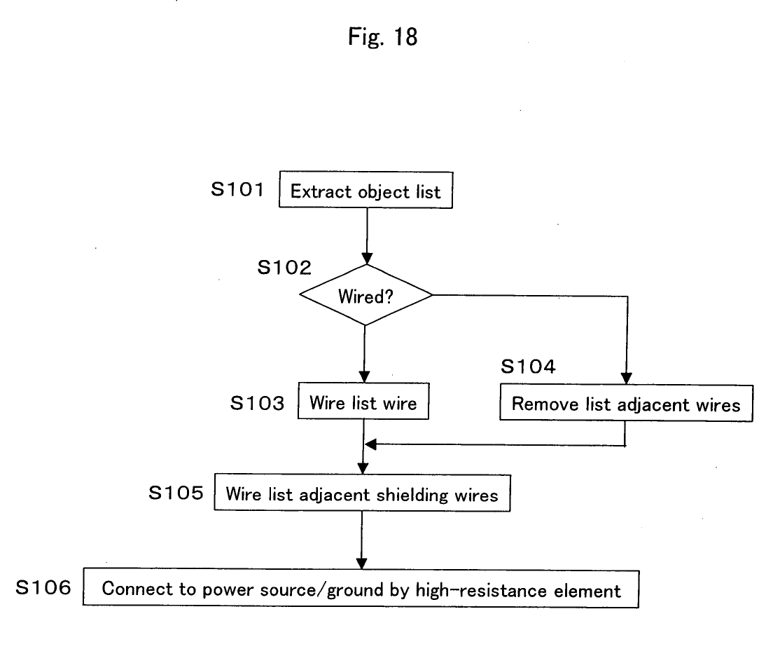

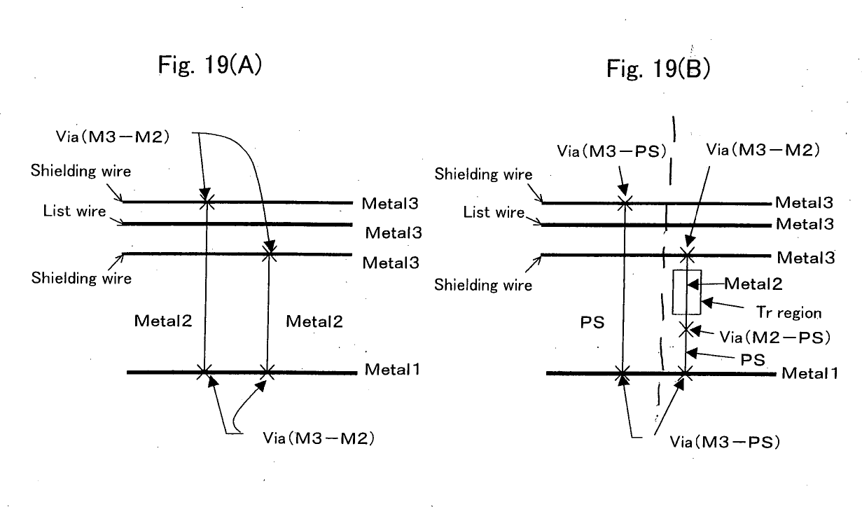

An eighth embodiment of the present invention will be described with reference to FIGS. 18 and 19. First, the embodiment of the present invention will be described with reference to the flowchart shown in FIG. 18. At step S101, the list of wires, in the LSI, whose delay values are speeded up is extracted. The list can be extracted by adding conditions such as wires in the critical path after timing analysis, clock wires and high load capacity wires. Then, at step S102, it is determined whether a wire in the extracted list and adjacent wires have been wired or not. When the wires have not been wired, at step S103, the wire in the list is wired. When the wire in the list has been wired and the adjacent wires have been wired at step S102, at step S104, the adjacent wires are moved or removed so that the tracks of the adjacent wires of the wire in the list are empty, thereby securing adjacent wire tracks. It is necessary for the adjacent wires removed at this step to be re-wired after shielding wires are wired at step S105. Then, at step S105, the shielding wires are wired on the tracks of the adjacent wires of the wire in the list. Then, at step S106, the shielding wires wired at step S105 are connected to the adjacent power source/ground by use of a high-resistance element such as a PS resistance or an OD resistance.

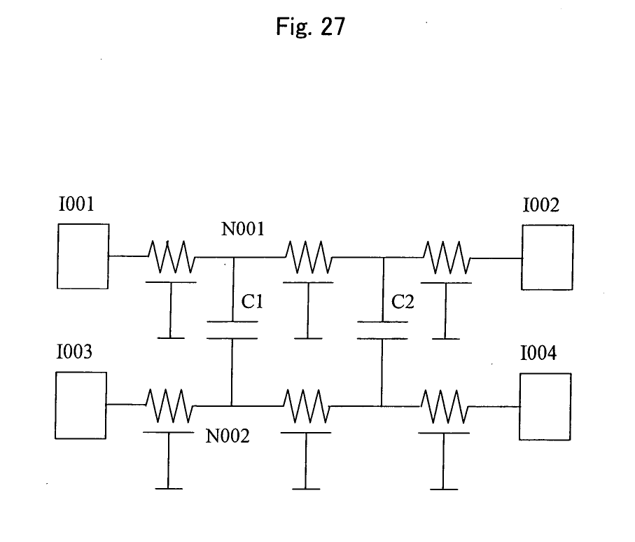

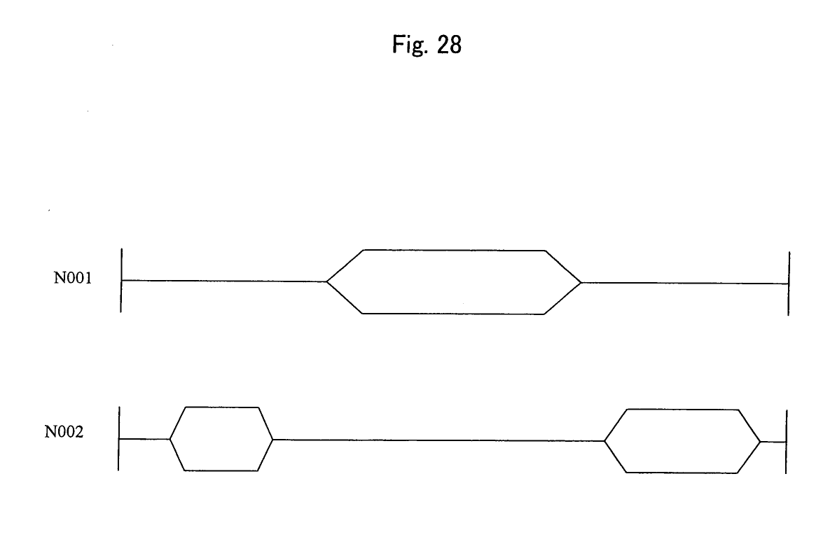

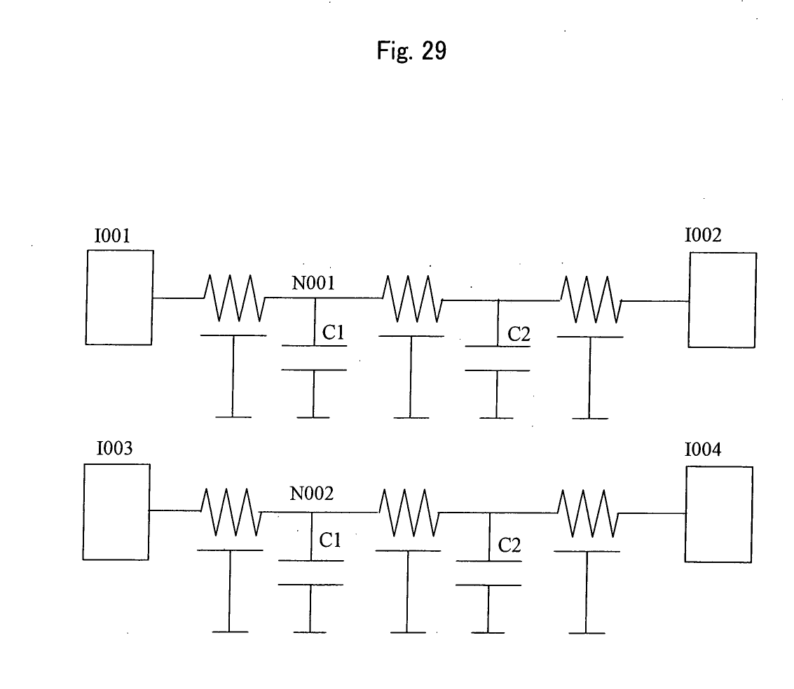

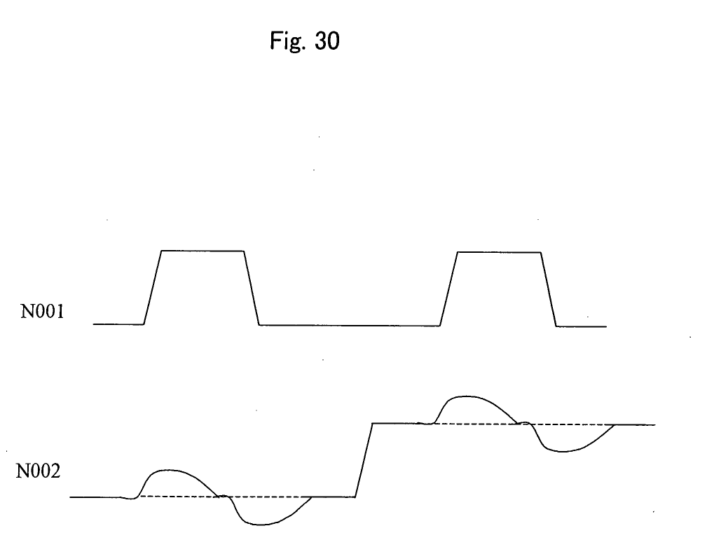

FIGS. 19(a) to 19(c) are connection diagrams showing connections to power source/ground by use of a high-resistance element. FIG. 19(a) shows a conventional connection using a low-resistance element. FIGS. 19(b) and 19(c) show connections to power source/ground using a high-resistance element. FIG. 19(b) shows a case where connection can be made only by a high-resistance element PS without any Tr element or the like provided between the shielding wire (Metal3) and the power source/ground (Metal1). FIG. 19(c) is a view in which when a transistor Tr element or the like is provided between the shielding wire and the power source/ground, a high-resistance element is inserted so as to avoid the Tr element. When a high-resistance element is present between the shielding wire and the power source/ground, the connection between the inter-wire capacitance stored between a shielded wire included in the list and the shielding wire, and the power source/ground is the same as the condition in which no input and output cell of the upper or lower wire in FIG. 27 is present, so that when the potential of the shielded wire changes, the potential of the shielding wire fluctuates as shown in FIG. 30 to reduce the apparent inter-wire capacitance and reduce the delay time of the shielded wire. In FIG. 30, the left part shows a case where the shielding wire is connected to ground, and the right part thereof shows a case where it is connected to the power source side.

As described above, according to the eighth embodiment, since the apparent load capacity of the shielded wire can be reduced by connecting the shielding wire to the power source/ground by use of a high-resistance connection, the delay time of the shielded wire can be reduced and the delay time which is deteriorated due to the high load capacity with the shielding wire can be reduced while the noise reduction effect by the conventional shielding wire is maintained, so that the LSI can be made faster.

### Ninth Embodiment

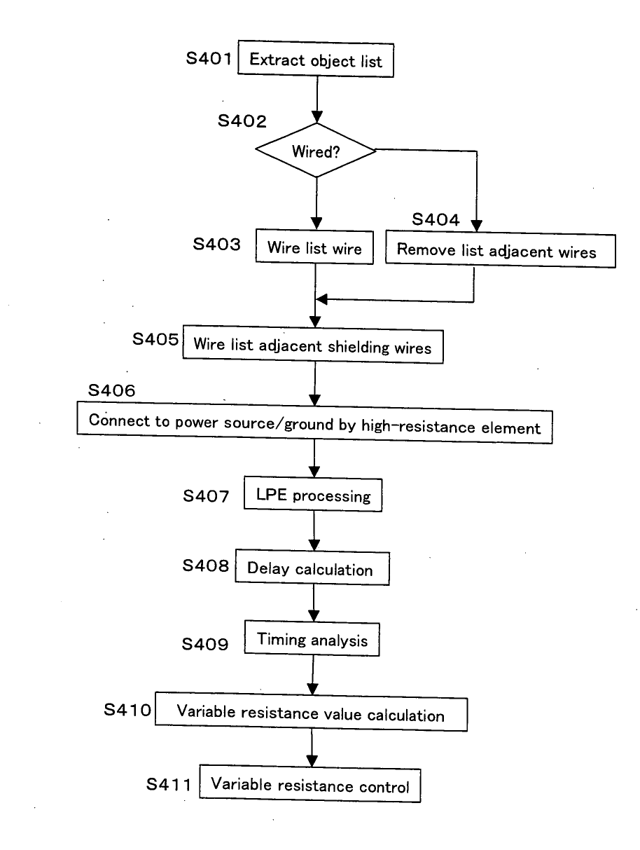

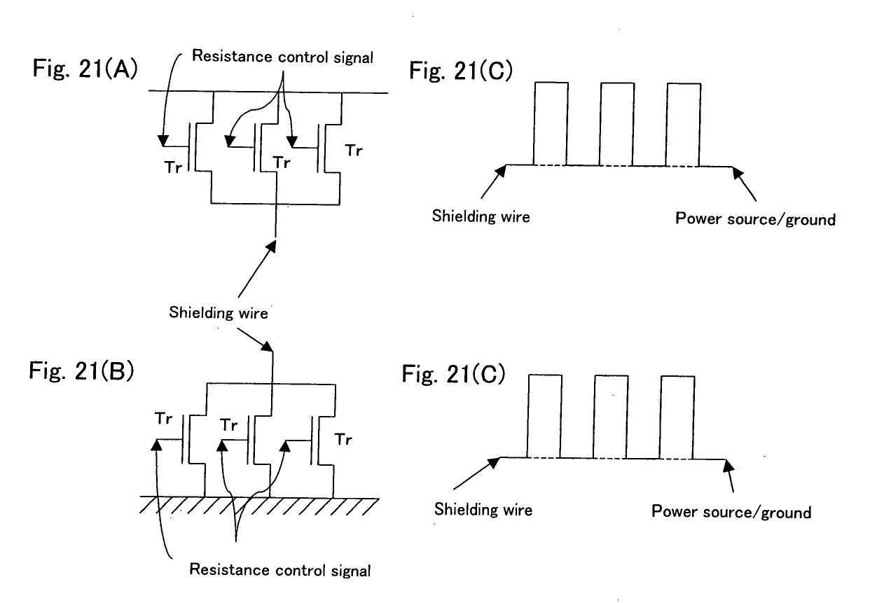

A ninth embodiment of the present invention will be described with reference to the flowchart shown in FIG. 20. Steps S401, S402, S403, S404 and S405 which are similar to steps S101, S102, S103, S104 and S105 in the eighth embodiment are characterized in that the list of wires, in the LSI, whose delay values are to be controlled is extracted (S401), it is determined whether a wire in the list has been wired or not (step S402), wiring processing when the wire has not been wired is performed (S403), wire change processing when the wire has been wired is performed (S404), shielding wires are wired in the neighborhood of the wire in the list (S405) and the resistance element connecting the shielding wires wired at step S405 to the power source/ground is made variable (step S406). Examples of the variable resistance element include an element as shown in FIG. 21. By connecting in parallel a plurality of transistors Tr to the power source in FIG. 21(a) and to ground in FIG. 21(b) and inputting a different control signal to each transistor Tr, the number of transistors Tr that turn on at the same time is adjusted, and by the number of ON resistances of the transistor Tr in parallel, the number of resistances is adjusted. The width of variation of the resistance value can be varied by changing the combination of the gate width and the channel length constituting the transistors Tr and the number of transistors Tr. In FIG. 21(C), lower resistance is realized by providing wires by a high-resistance layer and causing a short circuit between the wires. On the contrary, in FIG. 21(d), higher resistance is realized by previously causing a short circuit between the wires and deleting the short-circuited part as required. By combining FIGS. 21(c) and 21(d), the resistance value can be made variable.

Then, as typical processing, at step S407, LPE (layout parasitic extraction) is performed, at step S408, delay calculation is performed, and at step S409, timing verification is performed based on the delay calculation result, thereby calculating the timing error value. Then, at step S410, the resistance value between the shielding wire and the power source/ground which value is necessary for improving the timing error value obtained at step S409 is calculated, and at the next step S411, the number of transistors Tr that turn on is adjusted so that the resistance value is the value calculated at step S410, and processing is performed by causing a short circuit across the wire resistance element and deleting the short circuited part, thereby improving the timing error.

As described above, according to the ninth embodiment, by controlling the high-resistance element connecting the shielding wire to the power source/ground so that the delay value of the shielded wire is a desired value, the timing error can be improved without any modification to the circuit itself, so that the time required for designing the LSI can be reduced.

### Tenth Embodiment

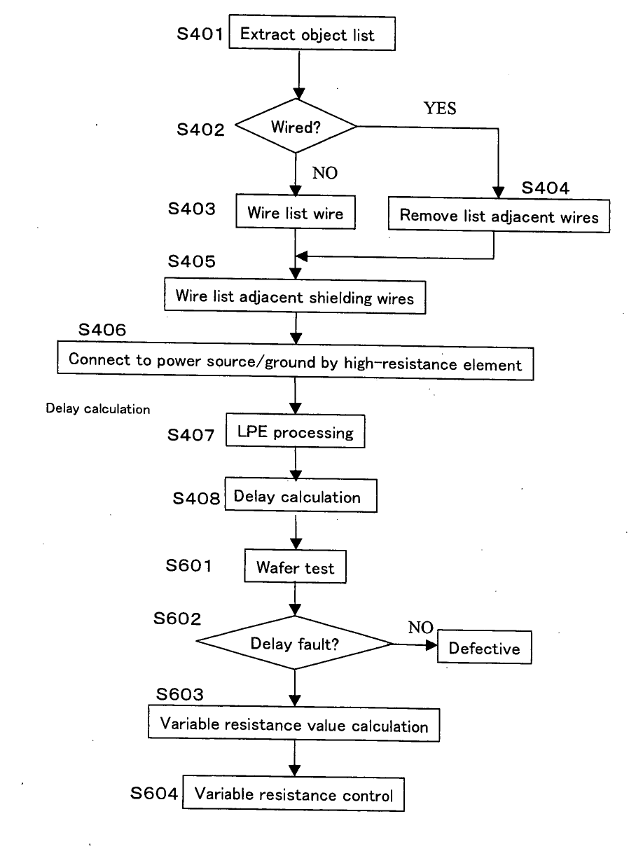

A tenth embodiment of the present invention will be described with reference to the flowchart shown in FIG. 22.

Steps S401 to S408 will not be described because they are the same as the steps designated by the same numbers in the ninth embodiment. At steps S401 to 405, a shielding wire is provided for a wire expected to require delay value control. Then, at step S406, the shielding wire and the power source/ground are connected by use of a variable resistance, and as the element constituting the variable resistance, an element capable of being modified by an external signal or after the manufacturing process is finished. For example, the control signal of the transistors Tr of FIGS. 21(a) and 21(b) is outputted as an external terminal of the LSI, or connected to an internal circuit capable of being controlled by an externally supplied microcode. Moreover, when a variable resistance using a wire resistance as shown in FIGS. 21(c) and 21(d) is constituted, it is necessary to shift the modified part to the uppermost layer so that wire connection or deletion can be performed in the uppermost wiring layer. Then, at steps S407 and S408, the RC information of the wire is extracted, and delay calculation is performed. Then, at step S601, the manufacture and pre-packaging test of the LSI are performed, and variation defects due to various factors are detected. In doing this, LSIs are determined that malfunction due not to a fault caused by an open or a short circuit but to the difference from the delay at the time of simulation before manufacture which difference is called a delay fault (S602). The wire which is the cause of the delay fault is identified, the delay width that requires improvement is obtained, and the variable resistance inserted at step S406 is controlled so that the delay width is satisfied at steps S603 and S604 (similar to steps S410 and S411), thereby enabling the LSI.

As described above, according to the tenth embodiment, by controlling the high-resistance element connecting the shielding wire to the power source/ground so that the timing error after the LSI is manufactured is improved, the LSI can be enabled and LSIs that malfunction can be reduced, so that yield can be enhanced.

### Eleventh Embodiment

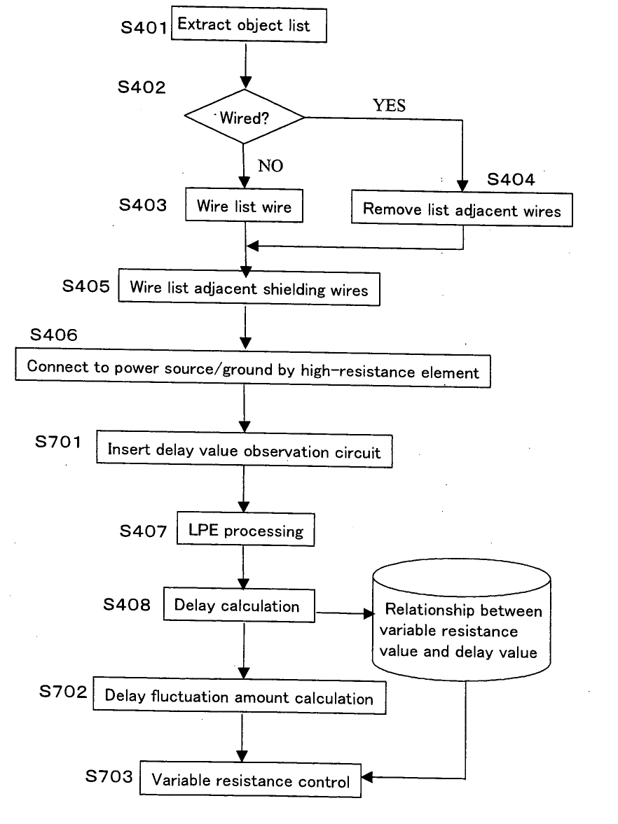

An eleventh embodiment of the present invention will be described with reference to the flowchart shown in FIG. 23.

Steps S401 to S408 and S411 (S703) will not be described because they are the same as the steps designated by the same numbers in the ninth embodiment. At steps S401 to 405, a shielding wire is provided for a wire expected to require delay value control. Then, at step S406, the shielding wire and the power source/ground are connected by use of a variable resistance. Then, the influence of the delay time fluctuation detected by an apparatus that detects the delay time fluctuation at a given point in the LSI, on the wire delay of the driven net is calculated, and the resistance value in the shielding wire is controlled so that the wire delay fluctuation of the driven net is suppressed.

That is, at step S701, a delay value observation circuit is inserted in the wire parts expected to require delay value control at step S401 and the signal wire parts associated with the wire parts. Then, at steps S407 and S408, extraction of the RC of the wires and delay calculation are performed. At step S408, calculation of the delay value of the shielded wire when the variable resistance is changed is performed as well as the normal delay calculation, and a database is created. The delay value observation circuit inserted at step S701 refers to a circuit that determines the part of the reference delay in a part of the LSI and compares the delay value of the wire shielded by the shielding wire to which the variable resistance is connected or a wire adjacent thereto. Then, when the delay difference compared at step S702 increases or decreases to be outside a predetermined range, a signal corresponding to the out-of-range amount is generated, and at step S703, the value of the variable resistance is controlled. The relationship between the delay value amount and the resistance value controlled at that time is derived from the database created at step S408.

While the delay value observation circuit is mentioned at step S701 in this example, a method may be used in which a temperature observation circuit or a voltage observation circuit is inserted and the result is fed back. While creation of a database is described at step S408, in addition to storing a combination of the delay calculation result and the resistance value in a memory in the LSI, a circuit may be added that is capable of controlling the variable resistance value by a combination of signals generated at step S702.

This example is characterized in that delay variations due to various factors caused in the operation of the LSI can be corrected while the LSI is operating.

This enables the manufacture of an LSI with a wide operation assurance range that is tolerant of variations in voltage, temperature and the like compared to LSIs manufactured by the conventional technology.

### Twelfth Embodiment

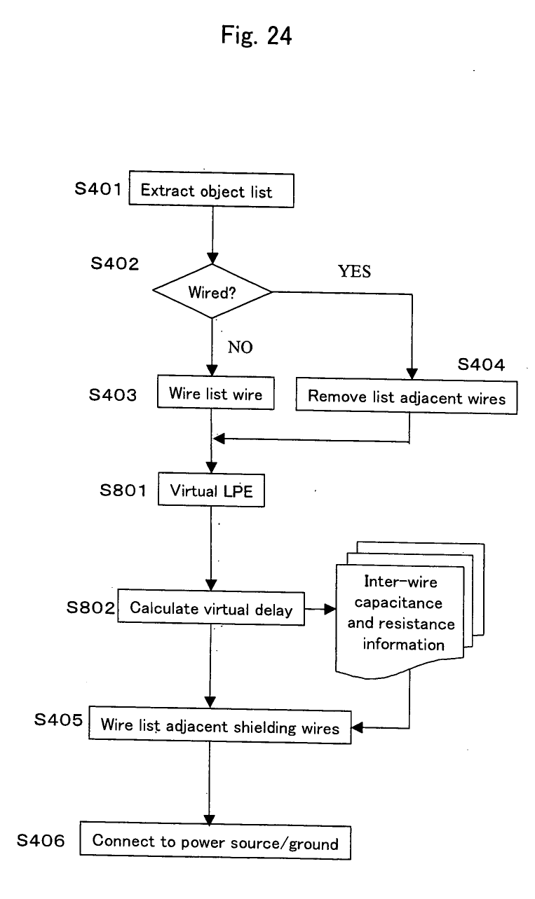

A twelfth embodiment of the present invention will be described with reference to the flowchart shown in FIG. 24.

Steps S401 to S404 will not be described because they are the same as the steps designated by the same numbers in the ninth embodiment. At steps S401 to S404, a region for providing the shielding wire is secured for the wires expected to require delay value control. Then, at step S801, the virtual inter-wire capacitances when the shielding wire is provided in the entire region and when no shielding wire is provided for the wires that require delay value control are calculated, and at step S802, a delay calculation between the calculated capacitances and based on the assumption that the shielding wire is connected by a resistance material having a specific temperature coefficient is performed. In doing this, when the delay of the wire that requires delay value control is changed in response to a temperature change and a restriction is placed on the circuit operation such as the operating speed, the inter-wire capacitance between the wire and a shielding wire capable of suppressing the delay fluctuation due to the temperature change and the resistance of connection to the power source/ground are calculated. Then, at step S405, the shielding wire is provided so that the inter-wire capacitance is the calculated one, and at step S406, the shielding wire and the power source/ground are connected by the calculated resistance value.

This example is characterized in that in consideration of the fact that a delay fluctuation due to a temperature change caused while the LSI is operating differs among signal paths, a circuit design that suppresses the fluctuation is made. This enables the manufacture of an LSI with a wide operation assurance range in which the power consumption is hardly larger than that of conventional circuits.

### Thirteenth Embodiment

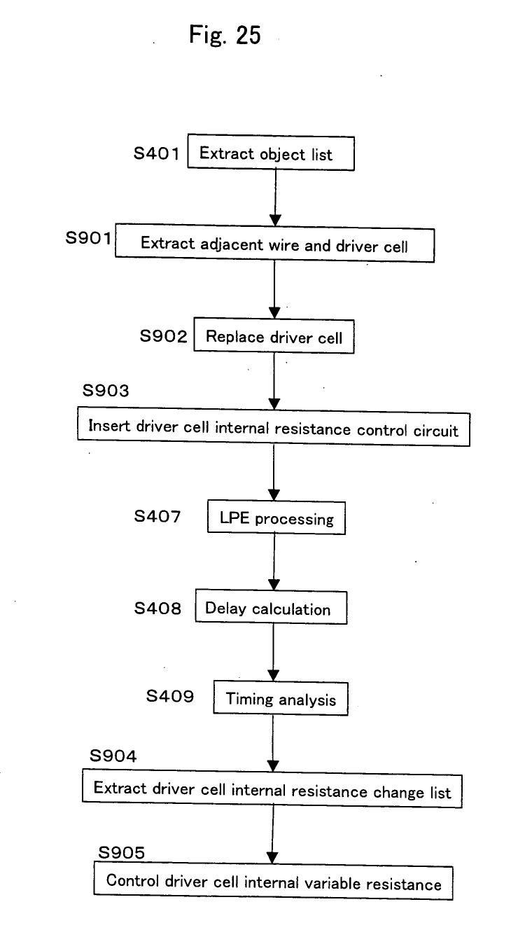

A thirteenth embodiment of the present invention will be described with reference to the flowchart of FIG. 25.

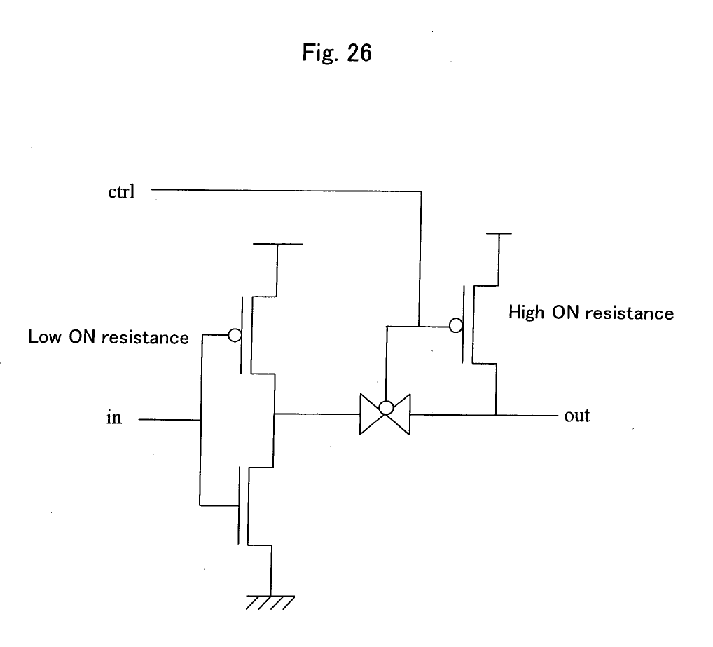

Steps S401 and S407 to S409 will not be described because they are the same as the steps designated by the same numbers in the ninth embodiment. First, at step S401, the list of signals that require delay value control is extracted. Then, at step S901, the driver cell that drives the wires adjacent to the extracted signal wire and the signals thereof on the layout is extracted. Then, at step S902, the extracted driver cell is replaced with a cell of the structure as shown in FIG. 26. Describing FIG. 26, in a circuit of a conventional structure, the in terminal and the out terminal are directly connected to a transistor Tr of a low ON resistance, and to this, a transistor Tr of a high ON resistance is added as an element and a circuit that disconnects the transistor of the low ON resistance is added in order to switch the element to which the out terminal is connected, whereby switching between transistors of different ON resistances can be made by the ctrl terminal. Then, at step S903, the circuit is modified so that a signal for ON resistance control can be inputted to the ON resistance control terminal of the replaced cell. At this time, the function for control is deactivated, and the activation of the delay control function is not performed. At the succeeding steps S407 to S409, similar processing to that in the ninth embodiment is performed. Then, at step S904, a path that requires delay time adjustment as the result of the timing analysis at step S409 is extracted, the ON resistance control circuit inserted at step S903 is activated, and at step S905, the variable resistance in the driver cell is controlled to thereby adjust delay.

This example is characterized in that for an LSI in which the degree of wire crowdedness is high and the area is not sufficient for inserting shielding wires, the influence on the delay of the adjacent wires is minimized by reducing delay by changing the ON resistance of the wires adjacent to the critical path. This enables the design of an LSI that is low in power consumption and is high in circuit operating speed compared to the conventional method in which replacement with a cell of high driving ability is performed for delay reduction.

1. A delay calculation method considering a net adjacent to a delay calculation object net of a semiconductor integrated circuit, said method comprising:
an adjacent net internal resistance selecting step of selecting a combination of static state of an adjacent net driving cell; and
a coupling capacitance grounding step of multiplying a coupling capacitance stored between the delay calculation object net and the adjacent net by a coefficient obtained from a delay calculation object net transition, the coupling capacitance, a wire resistance of the adjacent net and a wire capacitance of the adjacent net which are obtained from the delay calculation object net and the adjacent net, and an internal resistance of the adjacent net driving cell selected by the adjacent net internal resistance selecting step, and grounding a value obtained thereby as a coupling capacitance of the delay calculating object net,
wherein a delay value is derived from a circuit obtained by these steps.

2. A delay calculation method considering a net adjacent to a delay calculation object net of a semiconductor integrated circuit, said method comprising:
an adjacent net internal resistance selecting step of selecting a combination of static state of an adjacent net driving cell; and
a coupling capacitance replacing step of calculating a current that flows through a coupling capacitance obtained from a delay calculation object net transition, a coupling capacitance stored between the delay calculation object net and the adjacent net, a wire resistance of the adjacent net and a wire capacitance of the adjacent net which are obtained from the delay calculation object net and the adjacent net, and an internal resistance of the adjacent net driving cell selected by the adjacent net internal resistance selecting step, and replacing the coupling capacitance and the adjacent net with a current source,
wherein a delay value is derived from a circuit obtained by these steps.

3. A timing analysis method considering an influence of a delay value by a net adjacent to a net in a timing analysis object path of a semiconductor integrated circuit,
wherein timing verification is performed by using, as a verification condition for a timing verification path, a delay value obtained by the delay calculation method according to claim 1 or 2.

4. A calculation object network approximation method considering a net adjacent to a driven net which is an object of calculation, wherein in accordance with a value of an internal resistance of a driving cell of the adjacent net and a resistance value of a path from the driving cell of the adjacent net to an inter-net capacitance stored between the driven net and the adjacent net, it is determined whether to approximate the inter-net capacitance to connection to ground or to hold a connection of the inter-net capacitance to the adjacent net.

5. A calculation object network approximation method considering a net adjacent to a driven net which is an object of calculation, wherein an inter-net capacitance stored between the driven net and the adjacent net is approximated to connection to ground through a value of an internal resistance of a driving cell of the adjacent net and an equivalent resistance corresponding to a resistance value of a path from the driving cell of the adjacent net to the inter-net capacitance.

6. A calculation object network approximation method considering a net adjacent to a driven net which is an object of calculation, said method comprising: a step of calculating timing windows between the driven net and the adjacent net; and a step of, when the timing windows do not overlap, approximating to connection to ground an inter-wire capacitance stored between the driven net and the adjacent net by a capacitance and a resistance of the adjacent net and a value of an internal resistance of a driving cell.

7. A calculation object network approximation method considering a net adjacent to a driven net which is an object of calculation, wherein in accordance with a resistance value of the driven net up to a part constituting an inter-wire capacitance with the adjacent net and a value of the inter-wire capacitance, the inter-wire capacitance is approximated to connection to ground.

8. A delay control method wherein an electrically shielding wire is provided on a driven net which is an object of delay calculation, and the shielding wire is connected to a power source or ground by a high-resistance element.

9. A delay control method wherein an electrically shielding wire is provided on a driven net which is an object of delay calculation, the shielding wire is connected to a power source or ground by a controllable resistance element, and a resistance value in the shielding wire is controlled to thereby control a delay value of the driven net.

10. A delay control method wherein an electrically shielding wire is provided on a driven net which is an object of delay calculation, the shielding wire is connected to a power source or ground by a controllable resistance element, after an LSI is manufactured, operation verification is performed and a wire whose delay varies due to a variation in process is extracted, and a resistance value in the shielding wire is controlled to thereby control a varying delay value of the driven net.

11. A delay control method wherein an electrically shielding wire is provided on a driven net which is an object of delay calculation, the shielding wire is connected to a power source or ground by a controllable resistance element, an influence on a wire delay of the driven net is calculated from a delay time fluctuation detected by an apparatus that detects a delay time fluctuation at a given point in an LSI, and a resistance value in the shielding wire is controlled so that the wire delay fluctuation of the driven net is suppressed.

12. A delay control method wherein a delay fluctuation due to a temperature change of a shielded net is calculated, a capacitance stored between a shielded wire and a shielding wire that suppresses the delay fluctuation due to the temperature change of a driving cell of the shielded net and a resistance value of an element connecting the shielding wire to a power source or ground are calculated, an electrically shielding wire constituting the calculated inter-wire capacitance is provided on the shielded wire, and the shielding wire is connected to the power source or ground by the element of the calculated resistance value.

13. A delay control method wherein a plurality of elements that drive a wire adjacent to a driven net which is an object of delay calculation is connected, switching is made between an element when the adjacent wire is driven and an element when the adjacent wire is not driven, and an internal resistance of a driving cell of the adjacent wire is varied to thereby control a delay value of the driven net.
